(19) United States
(12) Patent Application Publication
(10) Pub. No.: US 2025/0129642 A1
(43) Pub. Date: Apr. 24, 2025

(54) DOOR HANDLE DEVICE

(71) Applicant: U-Shin Ltd., Nagano (JP)

(72) Inventor: Tomoya FUKUDA, Hiroshima (JP)

(21) Appl. No.: 18/918,839

(22) Filed: Oct. 17, 2024

(30) Foreign Application Priority Data
Oct. 24, 2023 (JP) 2023-182693

(51) Int. Cl. E05B 85/10; E05B 81/16; E05B 81/76

(52) U.S. Cl. CPC E05B 85/103; E05B 81/16; E05B 81/77

(57) ABSTRACT

The door handle device includes a base that defines a recess facing an opening of a door panel, and a handle that is adjacent to the opening and disposed on an outer side of the door panel, is pivotably supported by the base, and is capable of switching the latch mechanism to the release state by an outward pivot operation.

### BACKGROUND OF THE INVENTION

### Technical Field

The present invention relates to a door handle device.

### Description of the Related Art

JP 2013-151800 A discloses a bowl-shaped door handle device including a recessed portion formed in an outer panel of a vehicle door. When the door is opened, the user inserts a finger into the recess to operate the door handle device.

In the recess of the door handle device, there are provided an operation member that a user operates by pushing up with a finger, a detection switch that electrically releases the latch mechanism, and an emergency mechanism (including a lever and a cable) that mechanically releases the latch mechanism when the door cannot be electrically released (in an emergency) due to insufficient power of the in-vehicle battery. In a normal time, when the operation member is slightly pushed upward, the detection switch is turned on, and as a result, the latch-releasing motor is operated to electrically release the latch mechanism. On the other hand, in an emergency, when the operation member is greatly pushed upward, the lever of the emergency mechanism rotates. Since the lever is connected to the latch mechanism through the cable, the latch mechanism is released by the rotation of the lever.

### SUMMARY OF THE INVENTION

With the door handle device of JP 2013-151800 A, since the operation member is disposed in the recess, it is difficult to operate when an operation load required for push-up operation in an emergency, that is, an emergency operation, is high, and there is room for improvement in operability.

An object of the present invention is to improve the operability of an emergency operation in a door handle device.

One aspect of the present invention provides a door handle device including: a base, so as to define a recess facing an opening formed in a door panel of a vehicle door, disposed inside the door panel; a door opening operation detection unit disposed in the recess, the door opening operation detection unit configured to detect a user's operation for electrically releasing a latch mechanism that holds the vehicle door in a closed state in an openable manner with respect to the vehicle body; and a handle adjacent to the opening and disposed on an outer side of the door panel, the handle pivotably supported by the base, the handle connected to the latch mechanism through a traction member, the handle configured to switch the latch mechanism to a release state through the traction member by an outward pivot operation.

The handle is disposed outside the door panel so as to be adjacent to the opening of the door panel to which the recess in which the door opening operation portion is disposed faces. That is, the handle is not disposed in the recess but is disposed outside the door panel. Therefore, during an emergency operation, the user can easily access the handle. In addition, since the emergency operation is performed by the outward pivoting operation of the handle, the opening operation is easily performed. For these reasons, the operability of the emergency operation is improved.

The handle may be a bezel-type handle disposed so as to be along and adjacent to an opening edge of the opening and provided with an opening communicating with the recess at a center.

Since there are few opportunities to open the vehicle door during the emergency operation, providing a handle dedicated to the emergency operation results in an increase in the number of parts, an increase in the size of the door handle device, and an increase in cost associated therewith. By using the bezel-type handle as a handle for an emergency operation, that is, by using a bezel that is a decorative part also as a handle for an emergency operation, it is possible to suppress an increase in the number of parts and an increase in the size of the door handle device, and to reduce the cost.

One end side of the bezel-type handle may be pivotably supported by the base, and the other end side of the bezel-type handle may be capable of outward pivot operation.

The bezel-type handle is a relatively large component among components constituting door handle device. Therefore, in the outward pivoting operation on the other end side of the bezel-type handle having one end rotatably supported, the distance between the pivoting shaft and the operation position of the user increases, the operation load can be reduced by the lever principle, and the operability can be further improved.

A locking member configured to move by manual operation between a lock position where the locking member is engaged with the bezel-type handle and the bezel-type handle is held in a non-pivotable manner, and an unlock position where the bezel-type handle is made pivotable may be further included.

When a vehicle door is normally opened, which is not an emergency operation, that is, when the latch mechanism is electrically released by the door opening operation detection unit and subsequently the vehicle door is operated to be opened, the bezel-type handle is non-pivotably held by the locking member. Therefore, it is possible to prevent the bezel-type handle from being operated to be pivoted when the vehicle door is normally opened and to also secure operability when the vehicle door is normally opened.

The locking member may be disposed in the recess.

Since the locking member is disposed in the recess, the design of the outside of the vehicle body door is not impaired.

The bezel-type handle may be pivotable to an initial position disposed along an outer side of the door panel, a pop-up position at which the other end is raised from an outer side of the door panel, and an operation position at which the bezel-type handle is further pivoted from the pop-up position and the latch mechanism is operated to be released through the traction member. The door handle device may further include: a biasing portion configured to move the bezel-type handle from the initial position to the pop-up position when the locking member moves from the lock position to the unlock position, and a locking portion configured to hold the bezel-type handle at the pop-up position.

Emergency operation is used less frequently, and many users cannot understand an operation method. When the locking member is moved to the unlock position, the bezel-type door handle is at the pop-up position, so that the user can be prompted to perform the pivoting operation of the bezel-type door handle, and the user can sensuously perform an emergency operation.

The biasing portion may be a spring that elastically biases the bezel-type handle from the initial position toward the pop-up position. The locking portion may be a cable lever to which the traction member is connected.

With the spring and the lever, it is possible to configure a pop-up mechanism with a simple configuration, that is, a mechanism in which the bezel-type handle moves to the pop-up position when the locking member moves from the lock position to the unlock position.

According to the door handle device of the present invention, the operability of an emergency operation can be improved.

### BRIEF DESCRIPTION OF DRAWINGS

FIG. 1 is a front view of a door handle device according to an embodiment of the present invention;

FIG. 2 is a cross-sectional view taken along line II-II in FIG. 1;

FIG. 3 is an exploded perspective view of the door handle device according to the embodiment of the present invention;

FIG. 4 is a perspective view of the door handle device according to the embodiment of the present invention as viewed from the front side;

FIG. 5 is a perspective view of the door handle device according to the embodiment of the present invention as viewed from the rear side;

FIG. 6 is a block diagram of the door handle device according to the embodiment of the present invention;

FIG. 7 is a perspective view of an emergency mechanism as viewed from the front side;

FIG. 8 is a perspective view of the emergency mechanism as viewed from the back side;

FIG. 9 is a perspective view of a bezel-type handle as viewed from the front side;

FIG. 10 is a perspective view of the bezel-type handle as viewed from the back side;

FIG. 11 is a perspective view of the door handle device according to the embodiment of the present invention as viewed from the front side when the bezel-type handle is at an initial position;

FIG. 12 is a cross-sectional view taken along line XII-XII in FIG. 11;

FIG. 13 is a rear view of the door handle device according to the embodiment of the present invention when the bezel-type handle at an initial position;

FIG. 14 is a perspective view of the door handle device according to the embodiment of the present invention as viewed from the front side when the bezel-type handle is at a pop-up position;

FIG. 15 is a cross-sectional view taken along line XV-XV in FIG. 14;

FIG. 16 is a rear view of the door handle device according to the embodiment of the present invention when the bezel-type handle at a pop-up position;

FIG. 17 is a perspective view of the door handle device according to the embodiment of the present invention as viewed from the front side when the bezel-type handle is at an operation position;

FIG. 18 is a cross-sectional view taken along line XVII-XVII in FIG. 17;

FIG. 19 is a rear view of the door handle device according to the embodiment of the present invention when the bezel-type handle at an operation position;

FIG. 20 is a schematic front view of a door handle device according to a first modification;

FIG. 21 is a schematic front view of a door handle device according to a second modification; and

FIG. 22 is a schematic front view of a door handle device according to a third modification.

### DETAILED DESCRIPTION OF THE PREFERRED EMBODIMENTS

Next, a door handle device for a vehicle door according to an embodiment of the present invention will be described with reference to the accompanying drawings. In the drawings, an X direction indicates a vehicle length direction (plus indicates a front side), a Y direction indicates a vehicle height direction (plus indicates an upper side), and a Z direction indicates a vehicle width direction (plus indicates an outer side).

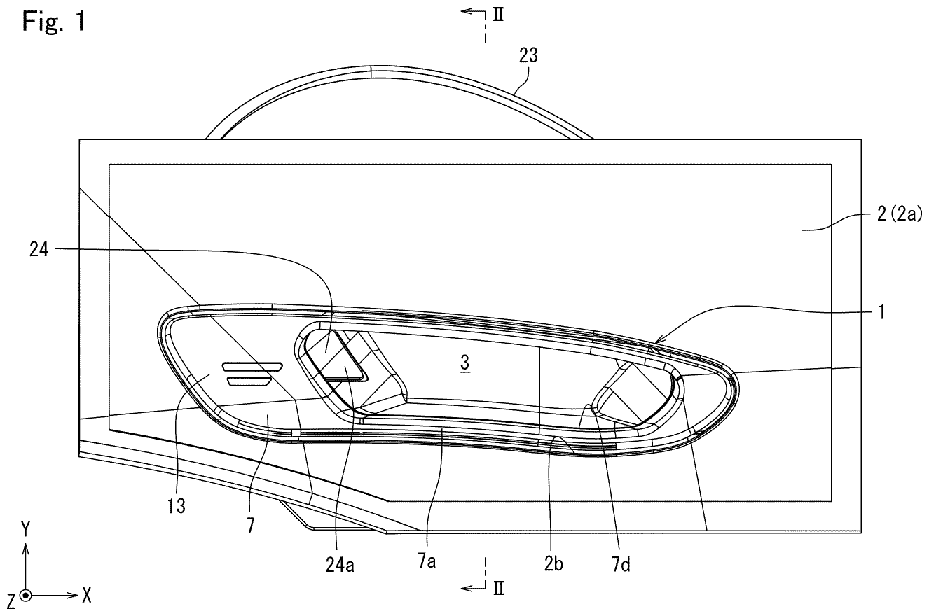

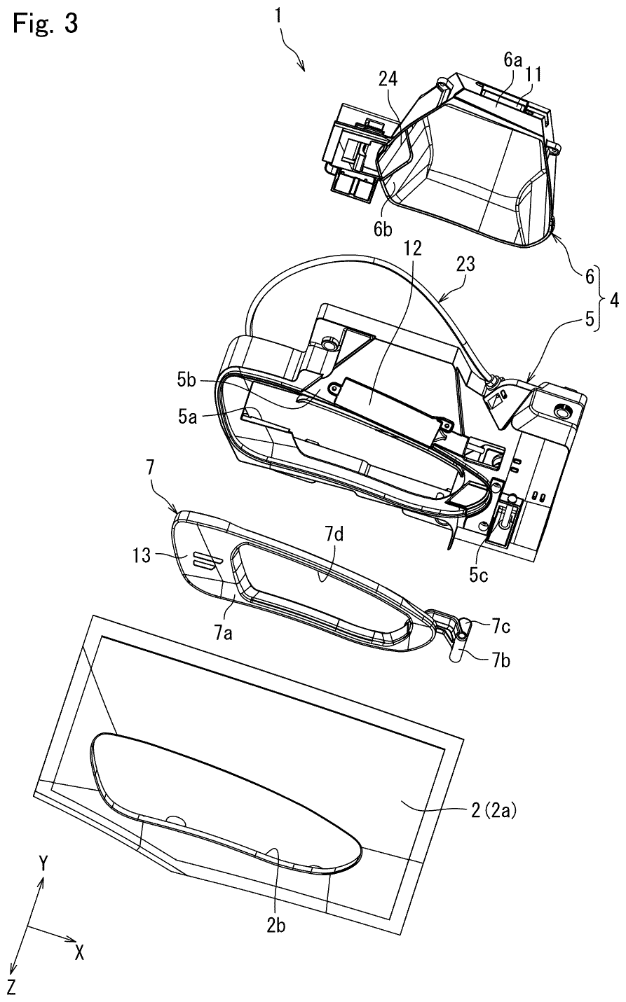

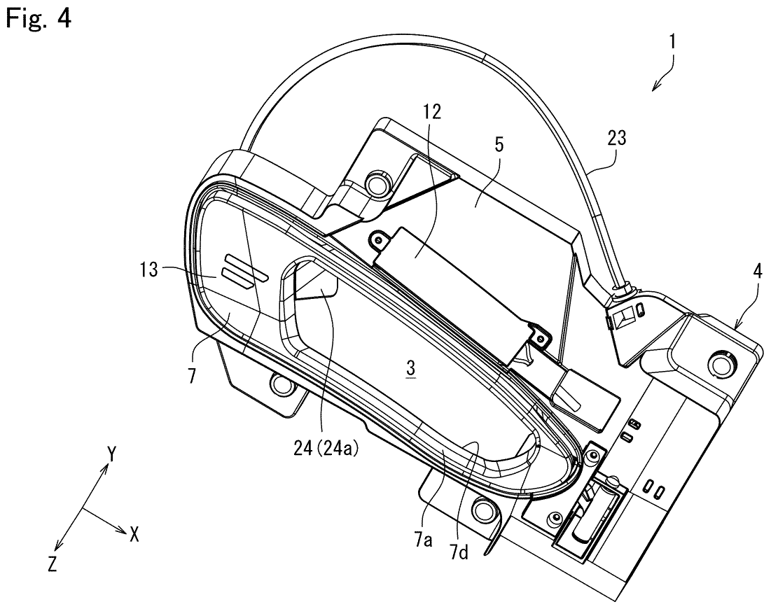

Referring to FIGS. 1 to 6, the door handle device 1 includes a base 4 fixed by screwing to the inside (vehicle interior side) of an outer panel (door panel) 2a of a laterally pivoting vehicle door 2. The base 4 faces an opening 2b elongated in the vehicle length direction formed in the outer panel 2a, and defines a recess 3 recessed from the outer side surface of the outer panel 2a toward the vehicle interior. As shown most clearly in FIG. 3, the base 4 includes a frame 5 provided with an opening portion 5a having a shape corresponding to the opening 2b and penetrating in the vehicle width direction, and a bowl 6 attached to the inside of the frame 5 to close the opening portion from the inside. The recess 3 is defined mainly by the bowl 6. In addition, the door handle device 1 includes a bezel-type handle 7 (described in detail below) pivotably supported by the base 4.

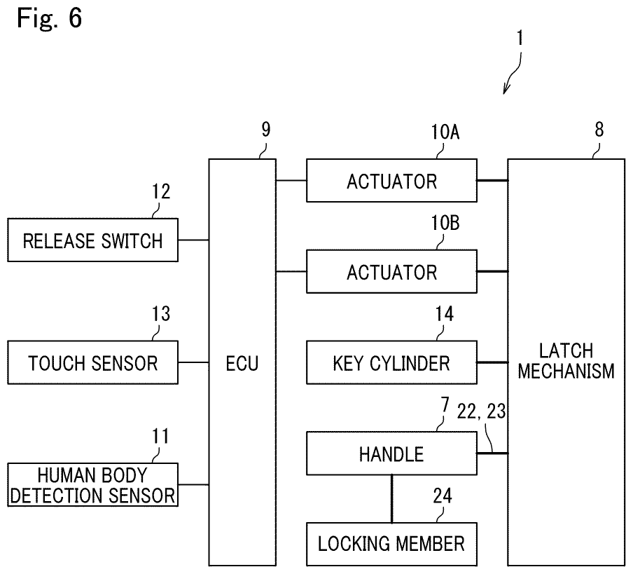

The door handle device 1 operates a latch mechanism 8 (schematically shown only in FIG. 6) provided in the vehicle door 2. The latch mechanism 8 has a well-known structure, and can hold the vehicle door 2 in a closed state in an openable manner with respect to the vehicle body. More specifically, the latch mechanism 8 includes a fork engaged with a striker provided on the vehicle body to be able to hold the vehicle door 2 in a closed state, and a latch engageable with the fork. The latch is switchable between a latched state in which the striker is held in a state of being engaged with the fork by being engaged with the fork and an unlatched state in which the striker is disengaged from the fork. In addition, the latch mechanism 8 can switch between an unlocked state in which the latch can be switched from the latched state to the unlatched state and a locked state in which the latch cannot be switched. At the normal time, that is, when the in-vehicle battery can supply necessary electric power, the door handle device 1 can electrically execute switching of latch mechanism 8 from the locked state to the unlocked state and switching of latch mechanism 8 from the latched state to the unlatched state. On the other hand, when the door cannot be electrically opened due to insufficient power of the in-vehicle battery (in an emergency), the door handle device 1 can manually execute switching of the latch mechanism 8 from the locked state to the unlocked state and switching of the latch mechanism 8 from the latched state to the unlatched state. Hereinafter, the operation of the door handle device 1 in an emergency may be referred to as an emergency operation.

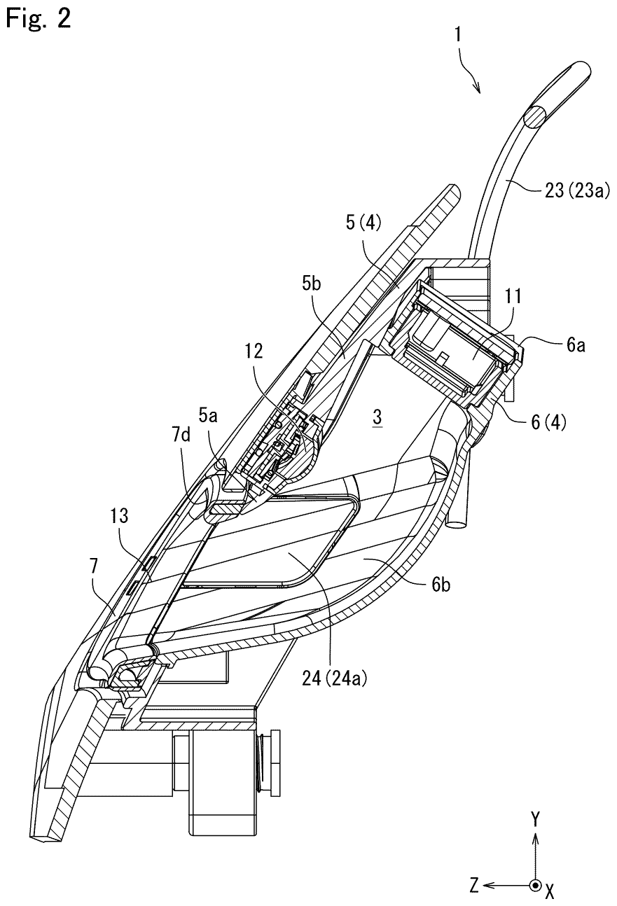

Referring to FIG. 2, when the latch mechanism 8 is in the unlatched state, the user inserts his/her hand (mainly a finger other than the thumb) into the recess 3 of the door handle device 1, grips the base 4, more specifically, the gripper 5b which is an upper portion of the opening portion 5a in the frame 5, and can pivot the vehicle door 2 to open the vehicle door 2 with respect to the vehicle body.

When the user pivots and closes the opened vehicle door 2, the fork of the latch mechanism is engaged with the striker, and the latch is mechanically switched from the unlatched state to the latched state.

Hereinafter, a configuration that the door handle device 1 has for electrically operating the latch mechanism 8 at the normal time and the operation thereof will be described.

The door handle device 1 includes an ECU 9 and two actuators (including at least motors) 10A and 10B, which are schematically shown only in FIG. 6. The ECU 9 controls the operations of the actuators 10A and 10B based on inputs from sensors and switches to be described below. The actuator 10A switches the latch mechanism 8 from the locked state to the unlocked state or from the unlocked state to the locked state. The actuator 10B switches the latch of the latch mechanism 8 from the latched state to the unlatched state.

Referring to FIGS. 2 and 6, the door handle device 1 includes a human body detection sensor 11 and a release switch 12 disposed in the recess 3. The human body detection sensor 11 is attached to the base 4, more specifically, the top wall 6a of the bowl 6. The human body detection sensor 11 is a capacitive sensor including an electrode as a detection means, and detects the hand of the user inserted into the recess 3. Instead of the human body detection sensor 11, another sensor that detects the hand of the user in a non-contact manner, for example, an infrared sensor can be adopted. In addition, in order to improve detection sensitivity, the electrode of the human body detection sensor 11 may be configured to be disposed along the edge portion of the gripper 5b of the frame 5. In the present embodiment, the release switch 12 is a mechanical switch, more specifically, a push-button switch. The release switch 12 is attached to the base 4, more specifically, the gripper 5b of the frame 5. The release switch 12 receives a user's command for switching the latch mechanism from the latched state to the unlatched state. The release switch 12 is not limited to a push-button type, and other mechanical switches or touch sensors can be adopted.

Referring to FIGS. 1 and 6, the door handle device 1 includes a touch sensor 13 attached to the bezel-type handle 7. The touch sensor 13 receives a user's command to switch the latch mechanism 8 from the unlocked state to the locked state.

In the opening of the vehicle door 2 at the normal time, the human body detection sensor 11 first detects the hand of the user inserted into the recess 3, and transmits a signal indicating the detection to the ECU 9. The ECU 9 having received the signal from the human body detection sensor 11 actuates the actuator 10A to switch the latch mechanism 8 from the locked state to the unlocked state. Next, when the user operates the release switch 12, a signal indicating the operation is transmitted from the release switch 12 to the ECU 9. The ECU 9 having received the signal from the release switch 12 actuates the actuator 10B to switch the latch of the latch mechanism 8 from the latched state to the unlatched state. With the above, the vehicle door 2 can be opened, and when the user inserts the hand into the recess 3, grips the gripper 5b, and pulls the gripper 5b toward the user, the vehicle door 2 is opened.

In the closing of the vehicle door 2 at the normal time, when the vehicle door 2 opened as described above is pivoted and closed, the latch of the latch mechanism 8 is mechanically switched from the unlatched state to the latched state. In this state, when the user touches the reaction portion of the touch sensor 13, a signal is transmitted from the touch sensor 13 to the ECU 9. The ECU 9 having received the signal from the touch sensor 13 actuates the actuator 10A to switch the latch mechanism 8 from the unlocked state to the locked state.

Next, a configuration that the door handle device 1 has for manually operating the latch mechanism 8 in an emergency will be described.

The door handle device 1 includes a key cylinder 14 (schematically shown only in FIG. 6) for manually switching the latch mechanism 8 from the locked state to the unlocked state. By inserting and turning a mechanical key (not shown) into the key cylinder 14, the latch mechanism 8 can be switched from the locked state to the unlocked state. The key cylinder 14 is provided, for example, on the outer panel 2a near the bezel-type handle 7, but it is not particularly limited in which place of the vehicle body the key cylinder 14 is provided.

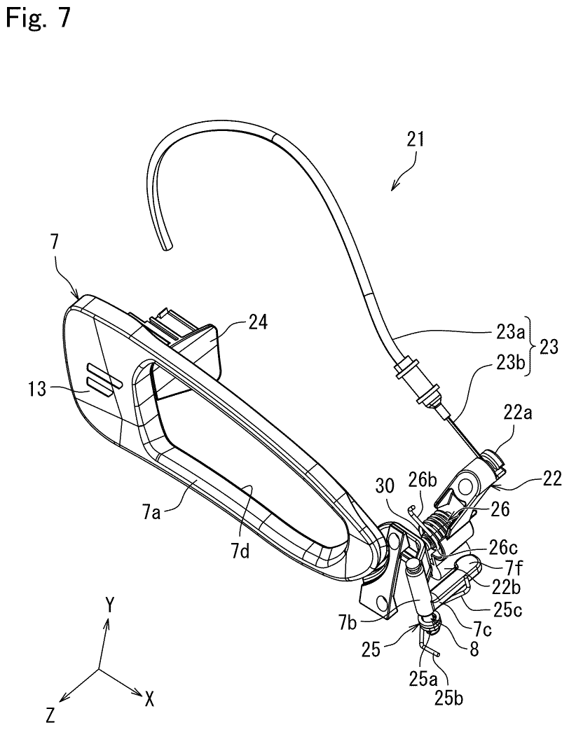

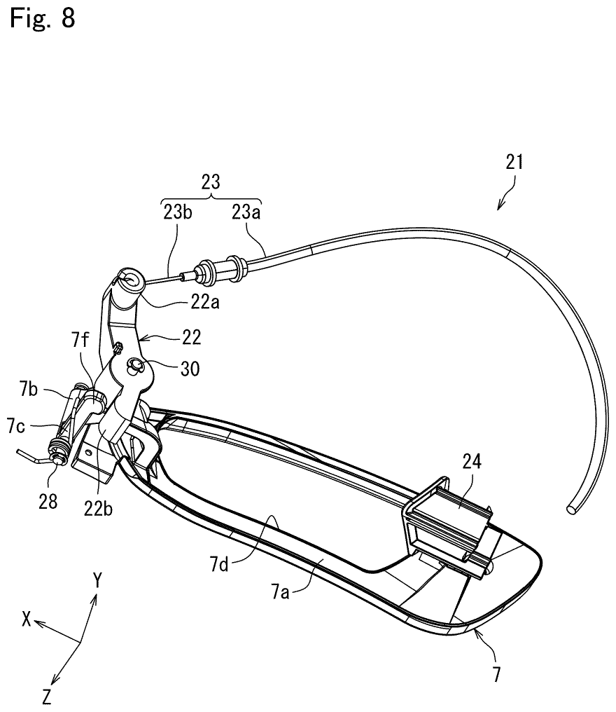

As shown most clearly in FIGS. 7 and 8, the door handle device 1 includes a mechanism for an emergency device, that is, an emergency mechanism 21. The emergency mechanism 21 in the present embodiment includes a bezel-type handle 7, a cable lever 22, a cable 23, a locking member 24, a first biasing spring 25, a second biasing spring 26, and a third biasing spring 27.

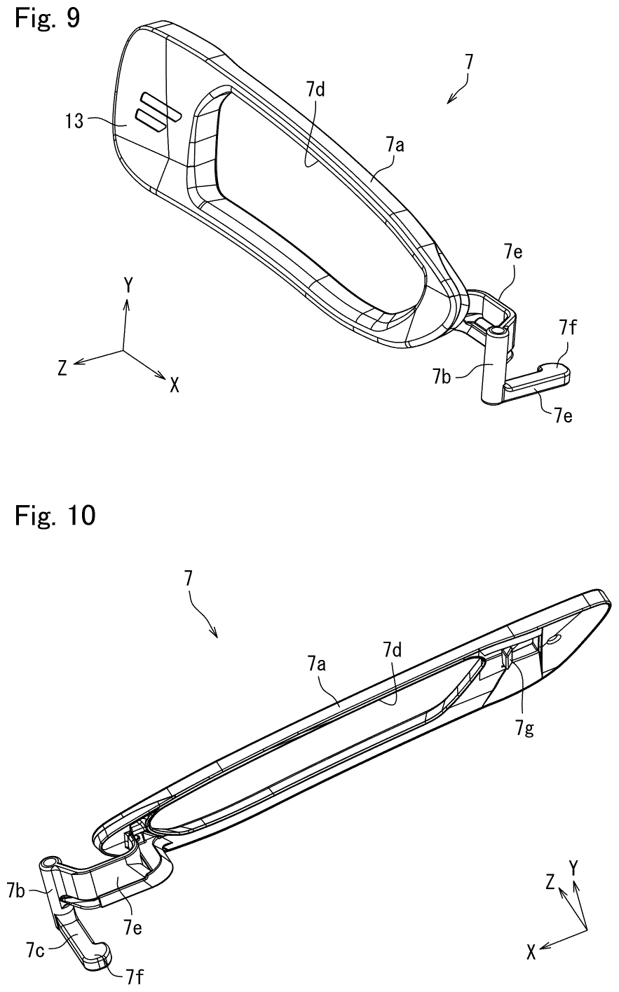

Referring also to FIGS. 9 and 10, the bezel-type handle 7 includes a handle main body 7a, a shaft support portion 7b, and an operation portion 7c. The shaft support portion 7b and the operation portion 7c are provided on one end side (front side in the vehicle length direction) of the handle main body 7a. As will be described in detail below, in the bezel-type handle 7, the shaft support portion 7b on one end side is pivotably supported by the base 4, but the other end side (the rear side in the vehicle length direction) opposite to the shaft support portion 7b, that is, the rear end of the handle main body 7a is not connected to the base 4 or the outer panel. As described above, the bezel-type handle 7 is supported by the base 4 in a cantilever mode, so to speak.

Referring to FIGS. 1, 11, and 12, the handle main body 7a is provided with an opening 7d at the center, and exhibits an elliptical annular shape elongated in the vehicle height direction as a whole in front view. When the bezel-type handle 7 is at the initial position (the position at the normal time), the handle main body 7a is disposed outside the outer panel 2a to be adjacent to the opening 2b provided in the outer panel 2a of the vehicle door 2, more specifically, to be adjacent along the opening edge of the opening 2b. Therefore, when the bezel-type handle 7 is at the initial position, the opening 7d of the handle main body 7a communicates with the recess 3. As will be described below, the handle main body 7a of the bezel-type handle 7 is a member for an operation for switching the latch mechanism 8 from the latched state to the unlatched state during an emergency operation, but at the normal time, functions as a decorative part for decorating the opening 2b provided in the outer panel 2a of the vehicle door 2.

Continuously referring to FIGS. 1, 9, 10, and 12, a touch sensor 13 is provided outside the handle main body 7a. On the other hand, a protrusion 7g which protrudes to the rear side in the vehicle length direction and with which, as described below, the locking member 24 is releasably engaged is provided inside the handle main body 7a.

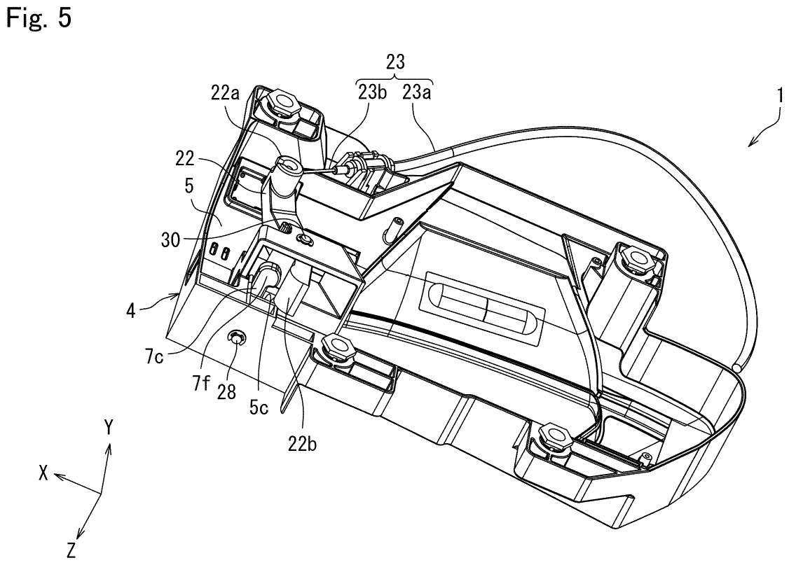

Referring to FIGS. 9 and 10, a base end of an extension portion 7e extending in the vehicle length direction is connected to the most one end side of the handle main body 7a, and a shaft support portion 7b is provided at a terminal of the extension portion 7e. The shaft support portion 7b has a cylindrical shape with both end openings extending in the vehicle height direction. The operation portion 7c extends inward in the vehicle width direction from the lower end side in the vehicle height direction of the shaft support portion 7b. Referring to FIGS. 5, 7, and 8, the first pin 28 fixed to the outer side of the base 4, more specifically the frame 5, in an attitude extending in the vehicle height direction is inserted into the shaft support portion 7b, whereby the bezel-type handle 7 is pivotably supported with respect to the base 4. In addition, the lower side in the vehicle length direction of the first pin 28 is inserted into the winding portion 25a of the first biasing spring 25 as a biasing portion. The first biasing spring 25 has one end portion 25b locked to the base 4 and the other end portion 25c locked to the operation portion 7c. Therefore, the bezel-type handle 7 is elastically biased in the opening direction by the first biasing spring 25.

Referring to FIGS. 5, 7, 8, and 13, since the operation portion 7c of the bezel-type handle 7 is inserted into the window hole 5c provided in the frame 5, the operation portion 7c penetrates the frame 5 from the outside to the inside, and the tip 7f is positioned inside the frame 5.

Continuously referring to FIGS. 5, 7, 8, and 13, the cable 23 includes an outer 23a and an inner cable 23b inserted therethrough, and the outer 23a is fixed to a cable stopper 29 provided inside the frame 5. The inner cable 23b has one end connected to the cable lever 22 and the other end connected to the latch mechanism 8.

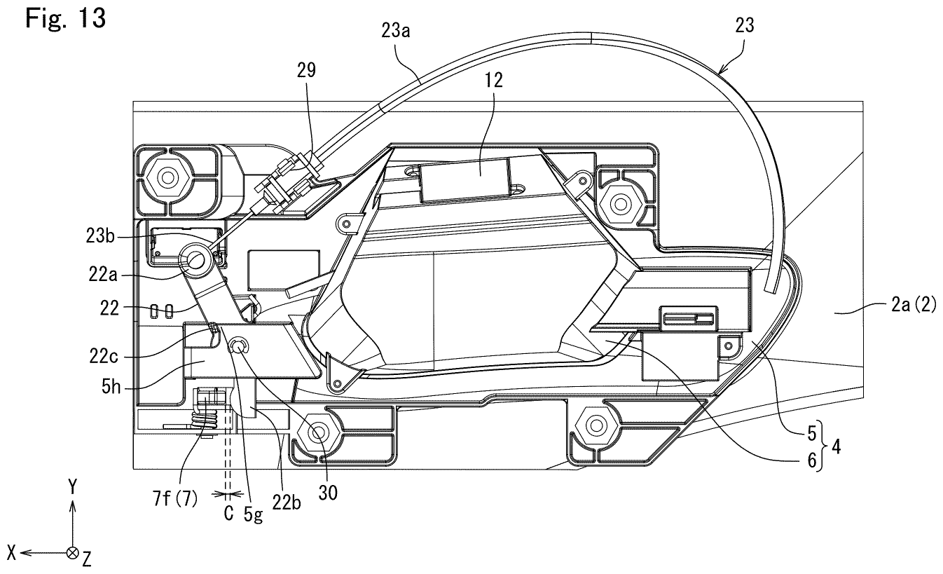

The cable lever 22 is disposed inside the frame 5. In addition, an intermediate portion of the cable lever 23 is rotatably supported by a second pin 30 fixed to the frame 5 in an attitude extending in the vehicle width direction. The cable lever 22 includes a cable connection portion 22a to which the inner cable 23b is connected at one end, and a portion to be operated 22b paired with the operation portion 7c of the bezel-type handle 7 at the other end. In addition, a protrusion 22c protruding toward the vehicle interior is formed between the intermediate portion of the cable lever 22 and the cable connection portion 22a. The second pin 30 is inserted through the winding portion 26a of the second biasing spring 26. The second biasing spring 26 has one end portion 26b locked to the base 4 and the other end portion 26c locked to the cable lever 22. Therefore, the cable lever 22 is elastically biased in the direction (clockwise direction in FIG. 13) in which the inner cable 23b is sent out by the second biasing spring 26. In addition, near the second pin 30 in the frame 5, a first stopper 5g facing the protrusion 22c in a contactable and separable manner on one side in the circumferential direction of the second pin 30 and a second stopper 5h facing the protrusion 22c in a contactable and separable manner on the other side in the circumferential direction of the second pin 30 are provided. The first stopper 5g and the second stopper 5h are disposed at an interval of approximately 90° in the circumferential direction, and regulate the circumferential pivot range of the cable lever 22. Therefore, when the bezel-type handle 7 is at the initial position before the operation, the cable lever 22 pivots to one side in the circumferential direction (clockwise in FIG. 13) by the biasing force of the second biasing spring 26, and is held in a state where the protrusion 22c abuts on the first stopper 5g.

As shown in FIG. 13, when the bezel-type handle 7 is at the initial position, the positions, dimensions, and shapes of the operation portion 7c and the portion to be operated 22b are set so that a gap C is formed between the tip 7f of the operation portion 7c of the bezel-type handle 7 and the portion to be operated 22b of the cable lever 22.

As will be described in detail below, when the bezel-type handle 7 pivots, the portion to be operated 22b of the cable lever 22 is pushed by the tip 7f of the operation portion 7c, and the cable lever 22 pivots. Then, when the cable lever 22 pivots, the inner cable 23b to which one end of the cable connection portion 22a is connected is pulled in, and as a result, the latch mechanism 8 to which the other end of the inner cable 23b is connected is switched from the latched state to the unlatched state.

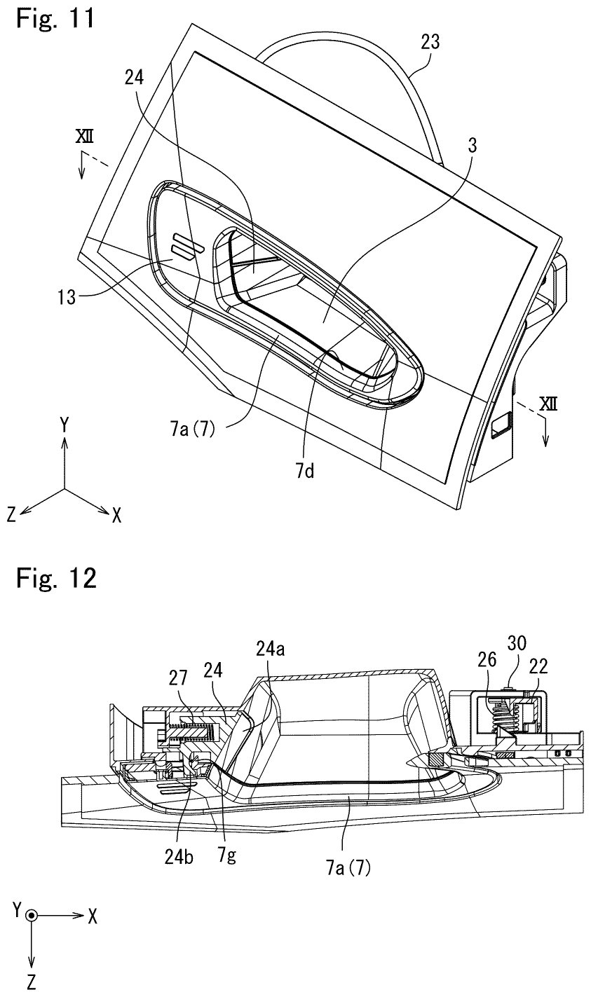

Referring to FIGS. 1 to 4, 7, and 8, the locking member 24 is provided in the recess 3, more specifically, on the side wall 6b on the rear side in the vehicle length direction of the bowl 6. The locking member 24 is provided to maintain the bezel-type handle 7 in a non-pivotable state at the normal time and to make the bezel-type handle 7 pivotable only during an emergency operation. Referring also to FIG. 12, the locking member 24 is supported by the bowl 6 in a linearly movable manner in the vehicle length direction, and the top portion 24a is exposed in the recess 3. The locking member 24 includes a protrusion 24b that protrudes outward in the vehicle width direction and further protrudes from an end portion thereof forward in the vehicle length direction. At the normal time, the tip of the protrusion 24b is engaged with the protrusion 7g of the bezel-type handle 7, on the outer side in the vehicle width direction. A third biasing spring 27 is compressed and mounted between the side opposite to the top portion 24a of the locking member 24 and the bowl 6. The locking member 24 is elastically biased toward the front side in the vehicle length direction by the third biasing spring 27. Due to this elastic biasing, at the normal time, the tip of the protrusion 24b is maintained in a state of being engaged with the protrusion 7g of the bezel-type handle 7 on the outer side in the vehicle width direction, whereby the bezel-type handle 7 is maintained in a state of being non-pivotable around the first pin 28.

Hereinafter, opening of the vehicle door 2 in an emergency, that is, an emergency operation will be described. At the time of starting the emergency operation, as shown in FIGS. 11 and 12, the bezel-type handle 7 is at an initial position disposed along the outer side of the outer panel 2a, and as shown in FIG. 13, a gap C is provided between the tip 7f of the operation portion 7c of the bezel-type handle 7 and the portion to be operated 22b of the cable lever 22. In the emergency operation, the user first inserts a mechanical key into the key cylinder 14 to rotate the key cylinder 14, and switches the latch mechanism 8 from the locked state to the unlocked state.

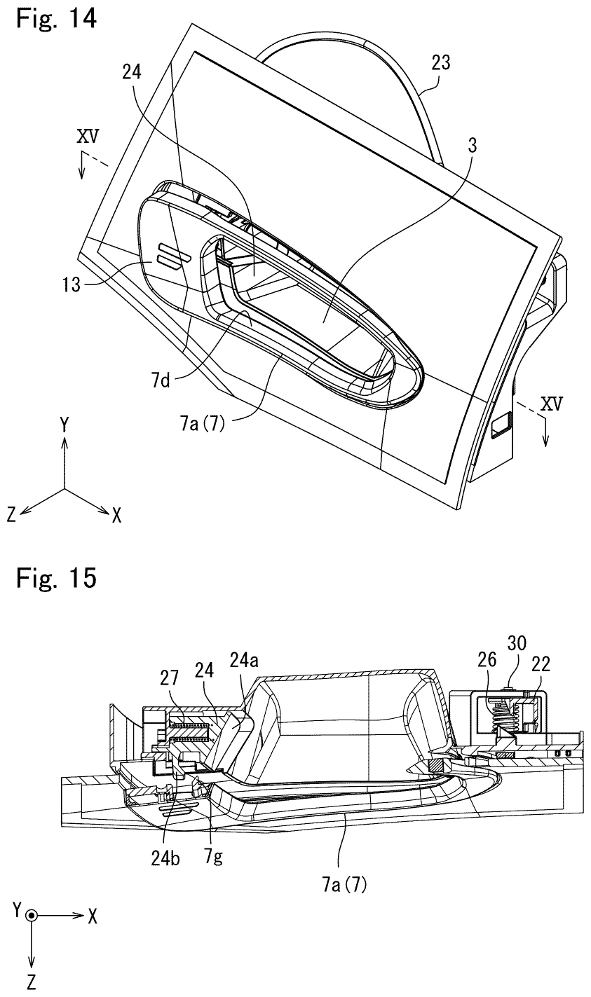

Next, the user inserts a hand into the recess 3 to push the lock member 24 toward the rear side in the vehicle length direction against the elastic biasing force of the third biasing spring 27. By this pushing of the locking member 24, the locking member 24 linearly moves from a position (lock position) where the tip of the protrusion 24b is engaged, on the outer side in the vehicle width direction, with the protrusion 7g of the bezel-type handle 7 as shown in FIG. 12 to a position (unlock position) where the engagement of the tip of the protrusion 24b with the protrusion 7g of the bezel-type handle 7 is released as shown in FIG. 15. That is, this pushing operation switches the bezel-type handle 7 from the non-pivotable state to the pivotable state. Releasing the engagement of the protrusion 24 of the locking member 24 with the protrusion 7g of the bezel-type handle 7 causes the bezel-type handle 7 to pivot around the first pin 28 by the elastic biasing force of the first biasing spring 25. By this pivot, as shown in FIGS. 14 and 15, the bezel-type handle 7 is at a pop-up position where the end portion on the rear side in the vehicle length direction (the end portion opposite to the first pin 28 and the shaft support portion 7b) is raised to the outside of the outer panel 2a. That is, the first biasing spring 25 elastically biases the bezel-type handle 7 so as to pivot from the initial position to the pop-up position.

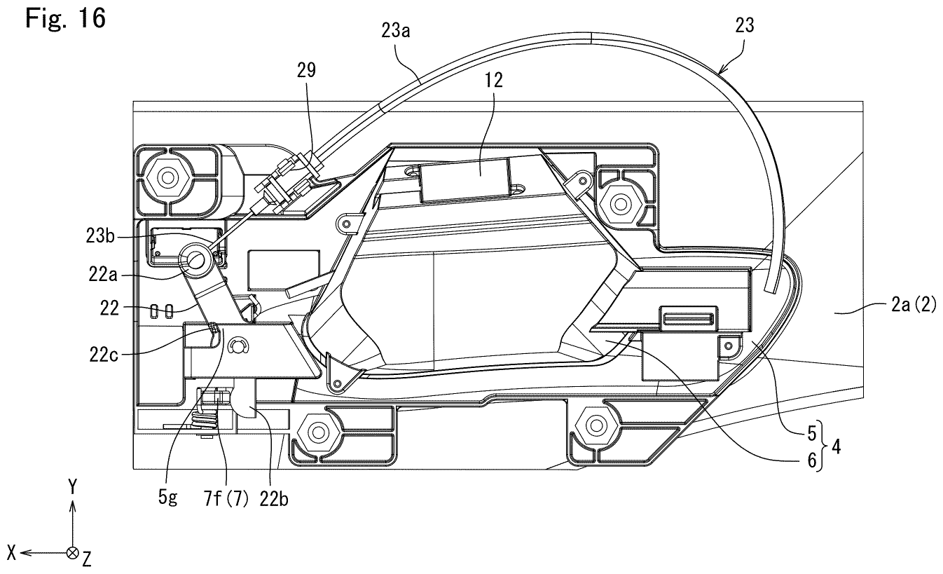

As shown in FIG. 16, the pop-up position is maintained by the tip 7f of the operation portion 7c of the bezel-type handle 7 abutting on the portion to be operated 22b of the cable lever 22. In other words, by the tip 7f of the operation portion 7c abutting on the portion to be operated 22b of the cable lever 22, the bezel-type handle 7 disengaged from the locking member 24 is held without further pivoting beyond the pop-up position by the elastic biasing force of the first biasing spring 25. At this time, since the biasing force of the second biasing spring 26 that biases the cable lever 22 is larger than the biasing force of the first biasing spring 25 that biases the bezel-type handle 7, the cable lever 22 is not pivoted by the biasing force of the first biasing spring 25.

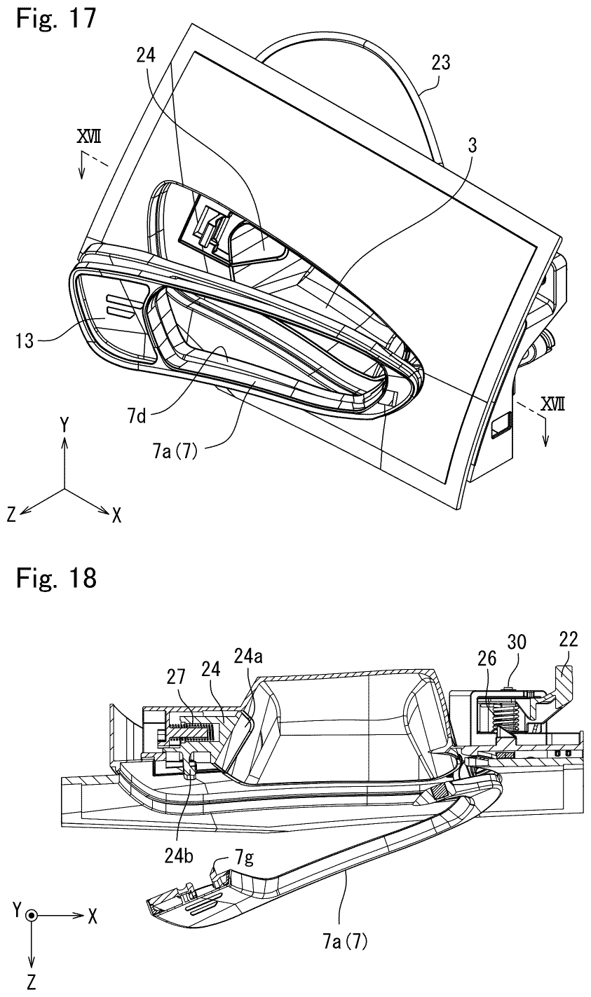

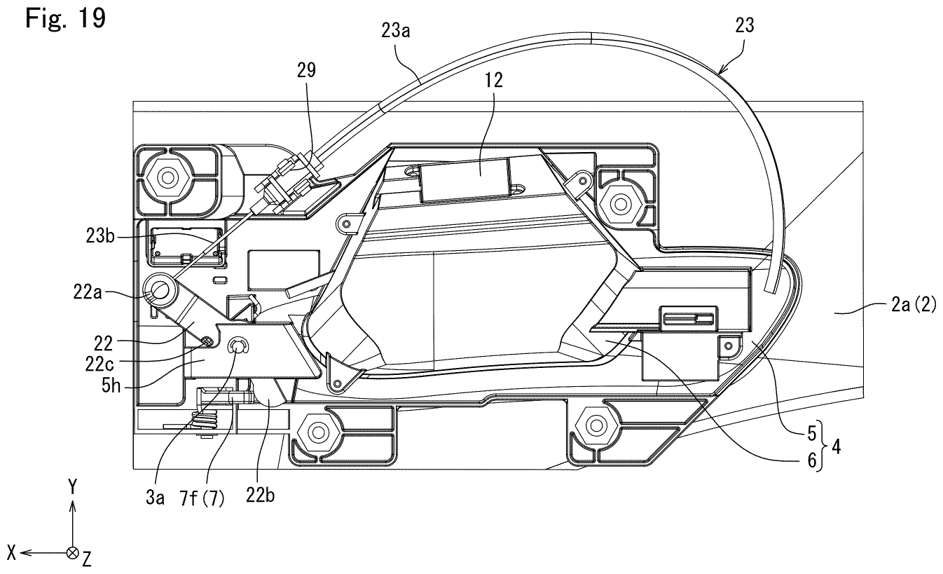

As shown in FIGS. 17 and 18, when the user further pivots the bezel-type handle 7 that has reached the pop-up position (FIGS. 14 and 15) outward in the vehicle width direction around the first pin 28 to set the operation position, the latch mechanism 8 is switched from the latched state to the unlatched state, and the vehicle door 2 can be opened with respect to the vehicle body as in the normal time. Specifically, the tip 7f of the operation portion 7c of the bezel-type handle 7 pushes the portion to be operated 22b of the cable lever 22 by the pivot of the bezel-type handle 7 from the pop-up position to the operation position. As a result, as shown in FIG. 19, the cable lever 22 pivots against the elastic biasing force of the second biasing spring 26. When the cable lever 22 pivots, the inner cable 23b connected to the cable connection portion 22a is pulled in, and the latch mechanism 8 is switched to the unlatched state.

The bezel-type handle 7 is disposed outside the outer panel 2a so as to be adjacent to the opening 2b of the outer panel 2a to which the recess 3 in which the release switch (door opening operation portion) 12 is disposed faces. That is, the bezel-type handle 7 is not disposed in the recess 3, but is disposed outside the outer panel 2a. Therefore, during an emergency operation, the user can easily access the bezel-type handle 7. In addition, since the emergency operation is performed by pivoting operation of the bezel-type handle 7 outward in the vehicle width direction, the opening operation is easily performed. For these reasons, the operability of the emergency operation is improved.

Since there are few opportunities to open the vehicle door 2a by the emergency operation, providing a handle dedicated to the emergency operation results in an increase in the number of parts, an increase in the size of the door handle device 1, and an increase in cost associated therewith. By using the bezel-type handle 7 as a handle for an emergency operation, that is, by using a bezel that is a decorative part also as a handle for an emergency operation, it is possible to suppress an increase in the number of parts and an increase in the size of the door handle device 1, and to reduce the cost.

The bezel-type handle 7 is a relatively large component among components constituting door handle device 1. Therefore, in the outward pivoting operation on the other end side of the bezel-type handle 7 having one end rotatably supported, the distance between the pivoting shaft and the operation position of the user increases, the operation load can be reduced by the lever principle, and the operability can be further improved.

When a vehicle door is normally opened, which is not an emergency operation, that is, when the latch mechanism is electrically released by the release switch 12 and subsequently the vehicle door 2 is operated to be opened, the bezel-type handle 7 is non-pivotably held by the locking member 24. Therefore, it is possible to prevent the bezel-type handle 7 from being operated to be pivoted when the vehicle door is normally opened and to also secure operability when the vehicle door is normally opened.

Since the locking member 24 is disposed in the recess 3, the design of the outside of the vehicle body door 2 is not impaired.

Emergency operation is used less frequently, and many users cannot understand an operation method. When the locking member 24 is moved to the unlock position, the bezel-type door handle 7 is at the pop-up position (FIGS. 14 and 15), so that the user can be prompted to perform the pivoting operation of the bezel-type door handle 7, and the user can sensuously perform an emergency operation.

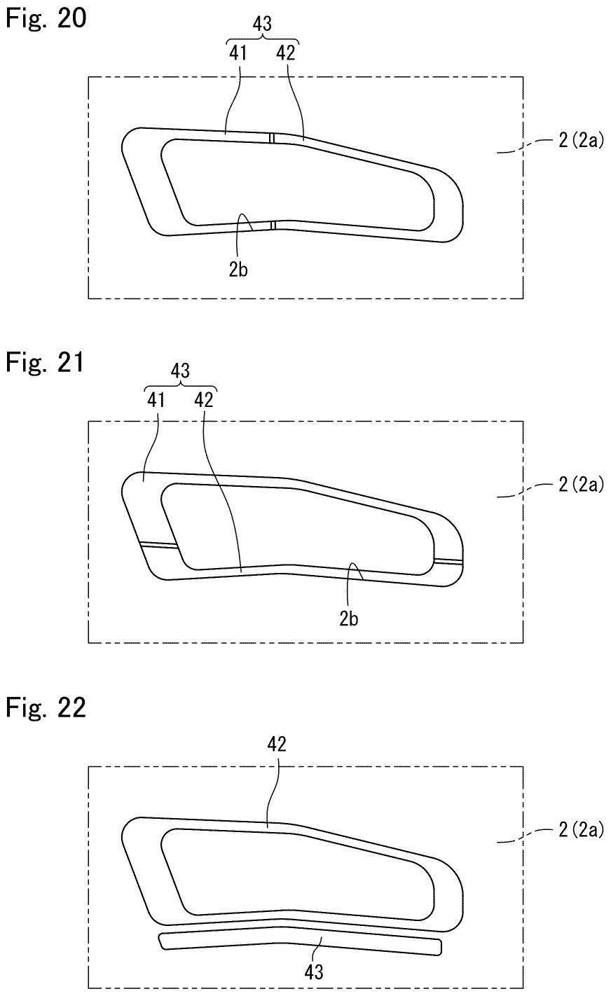

FIGS. 20 to 22 show a door handle device 1 according to a modification. In these modifications, points not particularly mentioned are the same as those of the above-described embodiment.

In the modifications in FIGS. 20 and 21, not the entire bezel 40 but a part thereof is a bezel-type handle 41 similar to that of the embodiment, and the remaining part is not a handle but a fixed decorative member 42. In the modification in FIG. 20, the rear side in the vehicle length direction of the bezel 40 is the bezel-type handle 41, and the front side in the vehicle length direction is the decorative member 42. In the modification in FIG. 21, the upper side in the vehicle height direction of the bezel 40 is the bezel-type handle 41, and the lower side in the vehicle height direction is the decorative member 42.

In the modification in FIG. 22, a handle 43 (having the same function as the bezel-type handle 7 of the embodiment) disposed on the outer panel 2a adjacent to the opening 2b of the outer panel 2a is provided separately from the fixed decorative member 42 rather than the handle.

What is claimed is:

1. A door handle device comprising:
a base, so as to define a recess facing an opening formed in a door panel of a vehicle door, disposed inside the door panel;
a door opening operation detection unit disposed in the recess, the door opening operation detection unit configured to detect a user's operation for electrically releasing a latch mechanism that holds the vehicle door in a closed state in an openable manner with respect to the vehicle body; and
a handle adjacent to the opening and disposed on an outer side of the door panel, the handle pivotably supported by the base, the handle connected to the latch mechanism through a traction member, the handle configured to switch the latch mechanism to a release state through the traction member by an outward pivot operation.

2. The door handle device according to claim 1, wherein the handle is a bezel-type handle disposed so as to be along and adjacent to an opening edge of the opening and provided with an opening communicating with the recess at a center.

3. The door handle device according to claim 2, wherein one end side of the bezel-type handle is pivotably supported by the base, and the other end side of the bezel-type handle is capable of the outward pivot operation.

4. The door handle device according to claim 3, further comprising a locking member configured to move by manual operation between a lock position where the locking member is engaged with the bezel-type handle and the bezel-type handle is held in a non-pivotable manner, and an unlock position where the bezel-type handle is made pivotable.

5. The door handle device according to claim 4, wherein the locking member is disposed in the recess.

6. The door handle device according to claim 4,
wherein the bezel-type handle is pivotable to an initial position disposed along an outer side of the door panel, a pop-up position at which the other end is raised from an outer side of the door panel, and an operation position at which the bezel-type handle is further pivoted from the pop-up position and the latch mechanism is operated to be released through the traction member, and
further comprising:
a biasing portion configured to move the bezel-type handle from the initial position to the pop-up position when the locking member moves from the lock position to the unlock position, and
a locking portion configured to hold the bezel-type handle at the pop-up position.

7. The door handle device according to claim 6,
wherein the biasing portion is a spring that elastically biases the bezel-type handle from the initial position toward the pop-up position, and
wherein the locking portion is a cable lever to which the traction member is connected.

8. The door handle device according to claim 5,
wherein the bezel-type handle is pivotable to an initial position disposed along an outer side of the door panel, a pop-up position at which the other end is raised from an outer side of the door panel, and an operation position at which the bezel-type handle is further pivoted from the pop-up position and the latch mechanism is operated to be released through the traction member, and
further comprising:
a biasing portion configured to move the bezel-type handle from the initial position to the pop-up position when the locking member moves from the lock position to the unlock position, and
a locking portion configured to hold the bezel-type handle at the pop-up position.

9. The door handle device according to claim 8,
wherein the biasing portion is a spring that elastically biases the bezel-type handle from the initial position toward the pop-up position, and
wherein the locking portion is a cable lever to which the traction member is connected.
